(19) United States
(12) Patent Application Publication
(10) Pub. No.: US 2005/0003247 A1
(43) Pub. Date: Jan. 6, 2005

(54) Co-production of hydrogen and electricity using pyrolysis and fuel cells

(76) Inventor: Ai-Quoc Pham, San Jose, CA (US)

Correspondence Address: Ai-Quoc Pham, Suite 305, 780 Montague Expressway, San Jose, CA, 95131, US

(21) Appl. No.: 10/884,657

(22) Filed: Jul. 1, 2004

Related U.S. Application Data
(60) Provisional application No. 60/484,331, filed on Jul. 1, 2003.
(60) Provisional application No. 60/484,488, filed on Jul. 1, 2003.

(51) Int. Cl. H01M 8/04; H01M 8/00; H01M 8/10; H01M 8/18; H01M 2/00; H01M 2/02

(52) U.S. Cl. 429/17; 429/19; 429/30; 429/33; 429/34; 429/13

(57) ABSTRACT

Among the possible technologies of small scale hydrogen production, pyrolysis is the cleanest hydrogen production process without purification, but suffered from low efficiency due to the carbon by-product. By the integration of a fuel cell to the pyrolysis reactor, the present invention provide a system to produce both hydrogen and electricity, and to utilize the would-be wasted by-products of the pyrolysis and fuel cell processes to improve the efficiency. The pyrolysis unit generates hydrogen from hydrocarbon fuel input, and produce solid carbon, which can be gasified to provide fuel source for the fuel cell to generate electricity. The fuel cell further functions as a steam and heat source for the gasification of solid carbon and possibly for the pyrolysis reaction. This results in an integrated system that not only generates both electricity and hydrogen, but does so at much higher efficiency as well as with greater simplicity and lower cost.

### CROSS-REFERENCE

This application claims benefit to U.S. Provisional Patent Applications No. 60/484,331, and 60/484,488 filed Jul. 1, 2003 which are hereby incorporated by reference in their entirety.

### BACKGROUND OF THE INVENTION

1. Field of the Invention

The present invention relates to an integrated system as well as method to generate both hydrogen and electricity.

2. Background

Concerns about greenhouse gas effects have generated great interest in the development of energy technologies with low emissions. Fuel cells, which use electrochemical process rather than direct combustion and have much higher efficiency than conventional power generation technologies, have the potential to reduce greenhouse gas emissions by half or more. For this reason, fuel cells are being considered for stationary power generation as well as for transportation.

In the near term, fuel cells must use fossil fuels because of the absence of a cheap source of hydrogen. Most fuel cells cannot operate directly on hydrocarbon fuels because of low reactivity of hydrocarbon and/or because of risks of harmful carbon deposition on the fuel cell electrodes. To date, most fuel cells require a prior fuel processing step to convert hydrocarbon fuels to a more reactive mixture containing CO and hydrogen. This mixture can be used directly in high temperature fuel cells such as Solid Oxide Fuel Cells (SOFCs) and Molten Carbonate Fuel Cells (MCFCs). Low temperature Polymer Electrolyte Membrane Fuel Cells (PEMFCs), the leading candidate in transportation applications however requires a pure hydrogen fuel source, and thus the mixture containing CO and hydrogen must be further purified to remove CO.

The addition of an intermediate fuel processing step to convert hydrocarbon fuels to more reactive and efficient fuels for fuel cells causes a drop in the overall system efficiency. For instance, a typical fuel processor efficiency is about 80%, when used with a PEMFC having about 50% efficiency, the system efficiency drops to about 40%. Moreover, the fuel processor adds a significant cost and complexity to the fuel cell system. This cost can be even higher than the fuel cell stack cost and the fuel processor size can be even larger than the fuel cell stack itself, especially for PEMFCs.

Furthermore, most fuel cells generate a significant amount of waste heat, both from the electrochemical oxidation of the fuel and from the combustion of the un-burnt fuel in the after-burner. Most of this heat is either released to the environment, resulting in loss of useful energy or is captured to generate hot water for instance, in Combined Heat and Power (CHP) applications. The issue is that there is not always a high demand for hot water, and not always at the same location as where the electricity is generated. In other instances, for SOFCs and MCFCs, the exhaust gas from the fuel cell can be used to further generate electricity using a gas turbine. This hybrid power generation mode can bring the fuel cell efficiency up from about 50% or less to about 70%. The issue here is that gas turbines are preferably operated at some pressures and high-pressure operation of current fuel cells is not easy and requires complex pressure vessels.

Thus one of the biggest hurdles that have hampered the deployment of fuel cells is the absence of an efficient hydrogen fuel infrastructure. Indeed, hydrogen is by far the preferred fuel for most fuel cells, and particularly for the PEMFCs. Hydrogen however is not readily available directly but must be produced from another source such as fossil fuels, biomass or water. While hydrogen production technologies using fossil fuels or water are well known, it is unlikely that they can be deployed as is for a future hydrogen economy since the production of hydrogen using water electrolysis is very expensive because of the high cost of electricity. Further, though hydrogen can be produced cheaply at large central plants, its delivery to on-site use can be costly and complex because of the low energy density of gaseous hydrogen.

To avoid the transportation and delivery issues, hydrogen should be produced on-site, i.e. close the locations where it will be used. The ideal scenario is the production of hydrogen directly at the refueling station. Hydrogen produced would be stored in high-pressure tanks and dispensed to the cars. Unfortunately, conventional technologies for producing hydrogen at large central plants cannot be scaled down to smaller sizes without an almost exponential increase in capital cost and efficiency lost.

Among the possible technologies of small scale hydrogen production such as steam reforming, partial oxidation and autothermal reforming, pyrolysis is the method to produce cleanest hydrogen without the additional step of hydrogen purification. A main reason why pyrolysis has not been widely used is because of the issue of what to do with the carbon by-product. The carbon retains a large part of the energy content in hydrocarbons, as much as 49% of the heat of combustion in the case of methane (Lower Heating Value, or LHV). As a result, the hydrogen efficiency is at best about 60% only. This is the lowest efficiency of all the small scale hydrogen production approaches mentioned above. For all other hydrocarbons, the heat contained in carbon is even higher and the hydrogen production efficiency is even lower because of the lower ratio of hydrogen to carbon. For instance, carbon in propane and butane gases retains as much as 57 and 59% of the LHVs, resulting in hydrogen efficiencies as low as 47 and 45% respectively.

A number of approaches have been proposed to make good use of the carbon black generated by the pyrolysis process. Beside the use for the rubber and metallurgical industries, carbon can be used to make hydrocarbons by hydrogenation or by gasification process with steam to produce a mixture of carbon monoxide and hydrogen. Carbon monoxide can subsequently be water-shifted to produced carbon dioxide and extra hydrogen. Carbon dioxide can then be filtered to produce purified hydrogen.

Most of the time, carbon black is suggested to be used for co-generation of heat or mechanical power through combustion, such as for the co-production of heat and hydrogen for residential or commercial buildings. The carbon is essentially burnt to generate heat for building heating and cooling. A regeneration process using oxygen to produce a carbon monoxide rich gas, which then is introduced to an internal or external combustion engine for production of mechanical power may also be used.

The approaches described above for the disposal of carbon black go somewhat against the original intention of developing a simple and clean source of hydrogen. Indeed, hydrogen and fuel cells are being developed worldwide as replacement of the conventional combustion approach because of the promise of generating lower emissions of both toxic and greenhouse gases. Disposing without making good use of the carbon black is a waste of natural resources. On the other hand, burning the carbon, which contains at least 49% of the energy content in hydrocarbons, is not much different than burning the hydrocarbon itself and consequently will not have noticeable impacts on the environment. Using steam to gasify the carbon black, followed by the conventional water shift and purification, eliminates the simplicity of the pyrolysis approach. It is not sure that this approach is any better than just doing the conventional steam reforming directly on the hydrocarbon fuels.

It would be a benefit to find new approaches to maximize the energy conversion in pyrolysis process together with the energy conversion in fuel cells beside the CHP scenario. We observe that the fuel cell operation is always exothermic while the hydrogen generation from fossil fuels is always endothermic. Since there is a need for efficient production of electricity and hydrogen, the integration of the two processes should be advantageous from both the system energy efficiency and the capital cost saving. The integrated system has application as an energy station providing both electricity and hydrogen—electricity for the neighborhood and hydrogen for refueling hydrogen vehicles.

### SUMMARY OF THE INVENTION

The present invention provides an approach to deal with the carbon that results from the pyrolysis of hydrocarbon. More generally, the present invention provides a system to produce both hydrogen and electricity by the integration of pyrolysis and fuel cell, and to utilize the would-be wasted by-products of the pyrolysis and fuel cell processes to improve the efficiency. The present invention system comprises at least a pyrolysis unit to generate solid carbon and hydrogen from hydrocarbons, and at least a fuel cell unit. The pyrolysis unit functions as the fuel reformer for the fuel cell, while also generating useful hydrogen fuel. The fuel cell functions as a steam/CO₂ and heat source for the gasification of solid carbon, while also producing electricity. The end result is an integrated system that not only generates both electricity and hydrogen, but does so at much higher efficiency than prior art as well as with greater simplicity and lower cost.

Under pyrolysis mode, hydrogen is produced in the pyrolysis unit using a thermal cracking process, or more preferably a catalytic cracking process, of hydrocarbon fuels and then is directed to storage for future dispensing. The cracking or pyrolysis also generates solid carbon by-product that remains in the reactor. The solid carbon builds up in the reactor and eventually slows down the pyrolysis reaction. To remove the carbon build-up, steam is then introduced into the reactor to gasify the solid carbon during the regeneration phase of the pyrolysis reactors. The gasification generates CO and hydrogen, or syngas, which is subsequently sent to a fuel cell to generate electricity. A portion of the fuel cell exhaust, which contains large quantities of steam and CO₂ is recycled by mixing with the steam for carbon gasification. The remaining portion of the exhaust is combusted in an after-burner to generate heat. The heat generated by the fuel cell and the after-burner is used to boil water and to supply to the endothermic pyrolysis and carbon gasification reactions.

One advantage of the present invention on hydrocarbon pyrolysis is that carbon is gasified using mostly “free steam” generated by the fuel cells, with all the heat required for the reaction and for boiling additional water, being supplied by the high-temperature fuel cell waste heat, not by burning some fuel or some carbon. The gasified carbon is used to generate electricity through the highly efficient electrochemical process in a fuel cell as opposed to through combustion as taught in the art. This electrochemical generation of electricity also generates heat that is supplied back to the gasification.

Another advantage of the invention is the flexibility in the production of hydrogen and electricity, i.e., either continuously and according to demands, using an integrated system involving the use of pyrolysis reactors and fuel cells. The relative amounts of hydrogen and electricity generation can be varied according to the needs of each. The system can generate up to 90% electricity (and the 10% hydrogen) when there is more need for electricity for the neighborhood and less hydrogen need for automobile, and changes continuously up to 90% hydrogen generation (and 10% electricity) when there is a high hydrogen demand. The change in the hydrogen and electricity outputs can be manually entered by an operator. Alternatively, the system can be equipped with a computer to analyze the demands and change the generation ratio automatically. In the case that only electricity is needed, the hydrogen gas is also directed to the fuel cell to generate electricity. The system can also involve more than one reactor. While one reactor operates in the pyrolysis mode to generate hydrogen (and solid carbon), the other reactor operates in the regeneration mode where the carbon is gasified and removed. Manifolds that comprise valves and controls are connected to the pyrolysis reactors and fuel to periodically alternate the hydrocarbon fuel and steam inputs to the reactors, and the hydrogen and gas mixture to the fuel cell outputs between the pyrolysis and regeneration modes of the reactors.

In addition, the present invention can operate without any additional water shift reaction steps to purify the hydrogen stream. The simplicity of the system can result in significantly lower capital cost.

Another advantage of the embodiment of the present invention is the fuel flexibility. Due to the fuel flexibility of the pyrolysis, i.e. because all hydrocarbons tend to decompose naturally to hydrogen and solid carbon at high temperatures, the present system can operate using a variety of hydrocarbon fuels. The change from one hydrocarbon fuel to another does not require any major modification of the hardware.

One significant innovation of the present invention is that it provides a novel method and an integrated system that can produce both electricity and hydrogen for the future hydrogen economy. This is achieved by coupling the electrochemical generation process of a fuel cell with the hydrocarbon pyrolysis process. The major benefits are the higher system efficiency as compared to stand-alone fuel cells or stand-alone reformers, and significantly lower capital cost because of the two-in-one benefit.

This new system is highly suitable for distributed hydrogen and electricity production scenario and has high potential for application as an energy station, by similarity with the current refueling station. In contrast with the conventional refueling stations that have only the role of a distributor, the proposed energy stations have the ability to produce both electricity and hydrogen on-site, using existing fuel infrastructure, thus circumventing the issue associated with hydrogen transportation and delivery.

### BRIEF DESCRIPTION OF THE DRAWINGS

The accompanying drawings, which are incorporated into and form a part of the disclosure, illustrate embodiments of the invention and, together with the description, serve to explain the principles of the invention. These drawings are not to be considered limitations in the scope of the invention, but are merely illustrative.

FIG. 1 shows schematically the integrated system that produces hydrogen and electricity. The system comprises a pyrolysis reactor and a fuel cell.

FIG. 2 schematically illustrates another embodiment of the system. FIG. 2A shows schematically the system as in FIG. 1 with the addition of a manifold between the reactor and the fuel cell. The manifold directs the output from the reactor to 1) a hydrogen output and 2) the fuel cell. FIG. 2B describes the system in the pyrolysis mode. Solid carbon is deposited in the reactor, while the hydrogen gas is directed to the output through the manifold. FIG. 2C shows the system in the regeneration mode. Carbon gasification reaction in the reactor produces hydrogen and CO gas mixture that is directed to the fuel cell through the manifold to generate electricity.

FIG. 3 shows schematically the system as in FIG. 2A but with two or more pyrolysis reactors. The reactors operate in the alternate mode—when one reactor is in the pyrolysis mode, the other reactor is in the regeneration mode, and vice versa. The system also comprises a manifold to switch alternatively the hydrocarbon fuel and the steam from one reactor to another.

FIG. 4 shows schematically the system as in FIG. 2A with an additional fuel cell connected to the hydrogen output of the manifold. The hydrogen generated from the pyrolysis reaction in the reactor thus is used to generate electricity in the additional fuel cell, and the system thus generates only electricity.

FIG. 5 shows schematically the system as in FIG. 2A with the hydrogen output directed to the fuel cell. The system generates only electricity.

FIG. 6 shows schematically another embodiment of the invention, similar to that shown in FIG. 2A. The sulfur impurity in the hydrocarbon fuel is removed in a desulfurization reactor prior to entering the reactor. The hydrogen output from the manifold is further purified through a methanation step. A portion of the exhaust from the fuel cell is recycled to the steam inlet of the reactor, and the remainder goes through an after burner and exhausted out.

FIG. 7 shows another embodiment of the invention. The system comprises 2 hydrocarbon fuel sources—source 1 is used for a system as in FIG. 6, and source 2 is fed to another fuel cell to generate electricity. The hydrocarbon fuel source 2 is sent through a desulfurization reactor and a pre-reformer reactor prior to entering the fuel cell. Unlike the system in FIG. 6, portion of the exhaust from the fuel cell is directed to the pre-reformer of the second fuel cell, while the exhaust from this fuel cell is directed to the steam inlet of the pyrolysis reactor.

FIG. 8 shows a system similar to that shown in FIG. 7, without the first fuel cell. The CO and hydrogen gas mixture output from the manifold during the regeneration reaction of the reactor is directed to the pre-reformer of the second fuel cell. A portion of the exhaust from the second fuel cell is also sent through an after burner before exhausted out.

FIG. 9 shows a system similar to that shown in FIG. 8. The CO and hydrogen gas mixture output from the manifold during the regeneration reaction of the reactor in this embodiment goes through a water shift reactor to the methanation reactor to produce pure hydrogen.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings enclosed are for the purpose of illustration and not a limitation of the invention. Those of ordinary skill in the art would recognize variations, modifications, and alternatives. Such variations, modifications, and alternatives are also within the scope of the present invention. Section titles are terse and are for convenience only.

The term “fuel cell” or “fuel cell unit” as used herein may mean a fuel cell stack or a plurality of fuel cell stacks operating in similar conditions and performing the same functions. It is well known that due to size limitations and other reasons, several identical fuel cell stacks can be connected together to form a fuel cell.

The terms “hydrocarbon pyrolysis” and “hydrocarbon cracking” as used herein may depict the same hydrocarbon decomposition reaction [reaction 3, described below] and thus have the same meaning.

The present invention discloses an integrated energy system capable of generating both electricity and hydrogen from hydrocarbon fuels by the integration of pyrolysis and fuel cell in which pyrolysis is mainly used to generate hydrogen while the fuel cell generates electricity. The combination of these two provides small scale co-production of hydrogen and electricity with much higher efficiency.

A number of technologies have been explored, developed or modified for small-scale hydrogen production, including small-scale steam reforming, partial oxidation and autothermal reforming.

Steam reforming consists of reacting hydrocarbon fuels with steam to create carbon monoxide and hydrogen. For methane fuel, the reaction is:
CH₄+H₂O→CO+3H₂ ΔH=206 kJ/mol CH₄ [1]

This reaction is highly endothermic and requires burning up to 25% of the fuel to provide the necessary heat. It also requires large excess of steam, as much as two to three time more steam than carbon, in order to prevent carbon deposition. The reactor designs are typically limited by heat transfer and consequently tend to be large and heavy.

Partial oxidation involves the use of a sub-stoichiometric amount of air or oxygen to partially combust the fuel. The combustion provides the energy needed to drive the reaction. Since no indirect heat transfer is needed, the partial oxidation processor is more compact and better suited for small-scale hydrogen production. The issue here is the large dilution of the fuel with nitrogen if air is used as oxidant. When considering the presence of steam, the dilution of useful fuel is even more severe. The dilution contributes to lower the electrochemical performance in fuel cell. Using the partial oxidation processor can reduce the fuel cell performance to less than 60% of what is normally observed if pure hydrogen were used as the fuel.

In contrast to the steam reforming, where the heat generated by the fuel cell can be used to promote the endothermic reforming reaction without the need to burn part of the fuel, the partial oxidation approach does not take advantage of the heat generated by the fuel cell. The partial oxidation consumes some of the energy content in the fuel during the combustion, and creates even more waste heat. As a result, the system efficiency is typically lower than that of systems using steam reforming to condition hydrocarbon fuels.

Autothermal reforming is a combination of the steam reforming and partial oxidation reactions. Autothermal reforming faces the same issue with dilution due to nitrogen in air.

For all three cases, the CO formed is subsequently water-shifted to produce more hydrogen, according to:
CO+H₂O→CO₂+H₂ ΔH=−41 kJ/mol [2]

This reaction is slightly exothermic and is typically performed in two reactors operating at high and low temperatures. The resulting hydrogen rich mixture can be used as a fuel for some fuel cells such as the Phosphoric Acid Fuel Cells but still contains to high a concentration of CO to be used in PEMFCs. Traditionally, CO is further removed using a preferential oxidation or methanation reactor. Hydrogen can also be separated out from the rest of the mixtures using gas separation techniques such as hydrogen permeable membrane or pressure swing adsorption. The use of hydrogen separation has the benefit of providing a pure hydrogen stream that can be stored in high-pressure tanks or metal hydrides. The incorporation of a hydrogen storage unit is necessary for a refueling station scenario.

Therefore, for all three cases above, due to the need to remove CO from the hydrogen stream, the overall system must contain at least four reactors. Beside the cost issue, the integration of all four reactors can be an engineering challenge, especially at small scales.

Hydrogen can be produced using pyrolysis, also called thermal cracking of hydrocarbons:
CₙHₘ→nC+m/2H₂ [3]

This reaction is endothermic. In the case of methane, the enthalpy is about +74.8 kJ/mol. The thermal cracking of methane thus requires burning less than 10% of the fuel to provide the heat. Solid carbon remains in the reactor and pure hydrogen gas is obtained. In theory, there is no need for any further gas separation, making the process extremely attractive.

The hydrocarbon cracking can be carried out either thermally at temperatures higher than 1200° C. or by using catalysts at temperatures below 1000° C. The advantage of catalytic cracking is the lower temperature operation. However, due to thermodynamic equilibrium, there is a higher residual unconverted hydrocarbon in the exit gas. In the case of methane, this is not an issue since methane is considered as inert for PEMFCs. Another issue is the possible presence of small quantities of carbon monoxide due to the reduction of the catalyst support. In this case, a simple methanation reactor can convert the CO to methane to produce CO-free hydrogen gas. This problem can also be eliminated by using the right support materials.

The overall advantages of the pyrolysis over the reforming reactions are: (1) no CO, thus no adverse effect on the PEM fuel cell catalyst, (2) no CO₂ nor nitrogen diluent in the hydrogen stream, thus allowing an increase utilization of hydrogen, and/or easier gas separation, (3) no complex steam management as is the case of steam reforming, (4) a simpler reactor design without the water-gas shift and steam generator units and, as a consequence, (5) a lower capital cost. The simplicity and low cost of the pyrolysis makes it highly suitable for small-scale generation. Furthermore, the pyrolysis approach has the potential for zero or very low greenhouse gas emissions since the carbon in hydrocarbon fuels is not released in the atmosphere, unless it is combusted.

The catalytic decomposition of natural gas is actually a process that has been commercialized. However, the process is not used presently, having been supplanted by the steam reforming for industrial-scale application, partly because of the disposing issue of the carbon by-product.

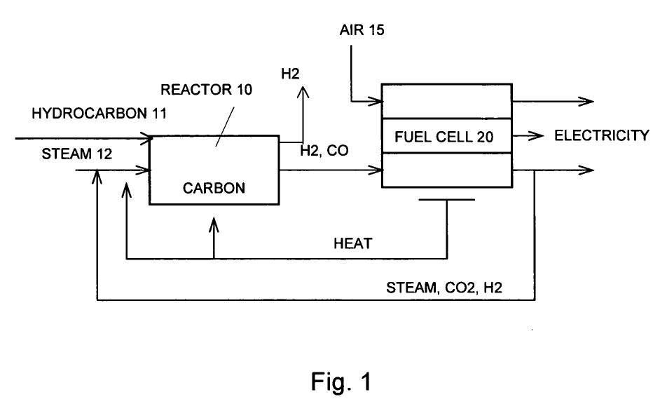

The present invention discloses a system and method to take advantage of the carbon by-product generated by the pyrolysis process. By converting the would-be wasted carbon by-product to energy, the present invention not only improves the overall efficiency but also reduces system complexity and minimizes wasted by-products. The present invention system thus comprises of at least one pyrolysis reactor, a fuel cell, and a manifold that connects the pyrolysis reactor and the fuel cell. FIG. 1 illustrates the schematic of the energy system that comprises a reactor 10 and a fuel cell 20. The reactor 10 can be of any size and dimension. The reactor 10 has input 11 for hydrocarbon fuel and input 12 for steam, and an output for hydrogen and an output to the anode of fuel cell.

The fuel cell can be either a Molten Carbonate Fuel Cell or preferably a Solid Oxide Fuel Cell. The fuel cell operates at temperatures higher than 400° C., and preferably 700° C. or higher, and can be of any stack design, including but not limited to tubular, planar or monolithic. Each fuel cell can comprise a plurality of identical fuel cell stacks connected together. The fuel cell also has an input 15 for oxygen-contained gas such as air to the cathode.

The hydrocarbon fuel that is fed to the cracking reactor may comprise a wide variety of possible fuels, contain hydrocarbon and exhibit exothermic reactions with oxygen. Examples of such hydrocarbon fuels include methane, ethane, propane, butane, and olefins, gasoline and diesel. Natural gas, propane gas and liquefied petroleum gas are the preferred fuels due to the available distribution infrastructure.

Since most hydrocarbon fuels contained some level of sulfur that can be harmful for the various catalysts, the hydrocarbon may be first flown through a sulfur removal reactor.

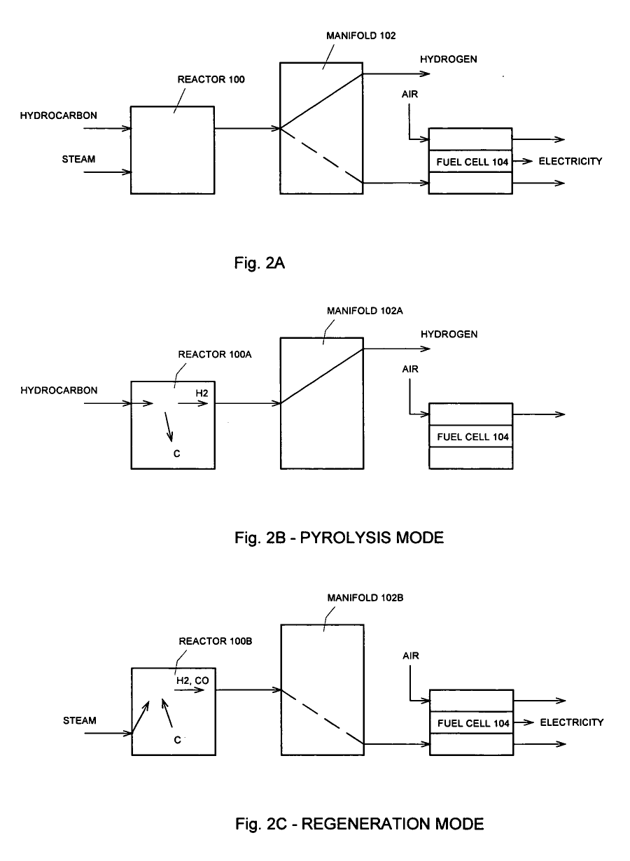

The pyrolysis reactor can operate in the pyrolysis mode and in the regeneration mode which can be explained in detail in FIGS. 2. Generally speaking, in the pyrolysis mode, the reactor generates hydrogen and solid carbon from the hydrocarbon fuel input, and in the regeneration mode, the reactor converts the solid carbon that generate hydrogen-containing gas mixture that is directed to the fuel cells. Optionally, the hydrogen output from the reactor during the pyrolysis mode can go through a methanation step to be further purified. The catalysts for hydrocarbon pyrolysis can be nickel, iron, cobalt, supported on a wide variety of materials such as alumina, silica, alumino-silicate, metal, alloys or carbon.

In a preferred embodiment, the output from the anode of the fuel cell is recycled back to the reactor 10 or to the input 12. Portion of the exhaust from the anode of the fuel cell that contains large quantities of heat, steam, CO₂, and hydrogen contained gas is recycled by directed to the reactor during the regeneration mode. Heat from the high temperature fuel cell is also used to help heating the reactor for the pyrolysis and carbon gasification reactions. This integrated design increases the efficiency of the system, since part of the exhausted energy from the fuel cell is recycled and used in the carbon gasification.

In another embodiment of the invention, the reactor has only one output for both hydrogen generated during the pyrolysis mode and CO and hydrogen gas mixture generated during the regeneration mode. In this configuration, the system employs the use of a manifold that connects the pyrolysis reactor to the fuel cell, as illustrated in FIG. 2A. In this embodiment, the reactor 100 has at least one input for hydrocarbon and at least one input for steam. The reactor has only one output that is connected to the manifold 102. The manifold 102 has two output—one to a hydrogen storage tank, and the other to the anode of the fuel cell to generate electricity. Also a portion of the exhaust from the fuel cell which contains large quantities of steam, heat, and CO₂, and other hydrogen contained gas can be recycled by directed to the pyrolysis reactor or the steam input to the reactor for carbon gasification. This integrated flow increases the efficiency of the system.

The pyrolysis reactor can also operate in the pyrolysis mode and in the regeneration mode. The operation of the pyrolysis mode is shown in FIG. 2B and the operation of the regeneration mode is shown in FIG. 2C.

In the pyrolysis mode, hydrocarbon fuel is introduced to the reactor. Under the effect of heat or heat and catalysts, hydrocarbon decomposes to generate solid carbon, which remains in the reactor, and hydrogen gas. Hydrogen gas leaving the reactor is directed to a manifold. The function of the manifold is to direct the output from the reactor 110 to either a hydrogen storage unit which may comprise a high pressure tank or a metal hydride tank, or to another fuel cell. When catalytic cracking of hydrocarbon is used, the hydrogen gas may contain some small amount of CO due to the reduction of the catalyst support. In this case, an optional methanation reactor may be used to convert hydrogen to methane that is inert for PEMFCs. This hydrocarbon cracking step proceeds until the reactor is full with carbon powder and/or until the catalyst activity deteriorates or declines. Once the catalyst becomes totally inactive, a regeneration step is required to restore the activity. Preferably, the cracking reaction is suspended to regenerate the catalyst before complete deactivation.

The reactor is then switched to the regeneration mode, shown in FIG. 2C. The purpose of the regeneration mode is to remove the solid carbon deposit that would degrade the pyrolysis reaction. In the regeneration mode, the hydrocarbon fuel is turned off or stopped from flowing into the reactor, and steam from an external source is introduced to the reactor. Steam enables carbon gasification, according to:
C+H₂O→CO+H₂ ΔH=131.4 kJ/mol [4]

The gasification is performed at a reactor temperature of about 700° C. or higher since high temperature is more favorable for complete conversion. Steam is introduced in excess amount as compared to stoichiometric ratio. Preferred steam to carbon molar ratio is higher than 1, more preferably higher than 1.5.

When all or most of the solid carbon has been gasified, steam is stopped, and the reactor is switched to the pyrolysis mode to generate hydrogen gas. The reactor continues to operate alternatively between the pyrolysis and regeneration modes to generate hydrogen and electricity, respectively.

The CO and hydrogen mixture generated by the gasification reaction, also called syngas, is subsequently directed to the fuel cell anode. Oxygen containing gas such as air, is fed into the fuel cell cathode. The air flow input into the cathode of the fuel cell can flow continuously, or can be modulated so flow only when the CO and hydrogen contained mixture is fed to the anode of the fuel cell. When an electrical current flows through the fuel cell, oxygen is electrochemically reduced to oxygen ions, according to:
O₂→O²⁻+2e⁻ [5]
wherein e⁻denotes an electron. The oxygen ions diffuse across the electrolyte membrane. Arriving on the anode side, oxygen ions react with the syngas according to:
H₂+O²⁻→H₂O+2e⁻ [6]
CO+O²⁻→CO₂+2e⁻ [7]

Reaction [7] is not very fast and CO is likely to react with steam according to reaction [2] to produce more hydrogen that can be consumed by reaction [6].

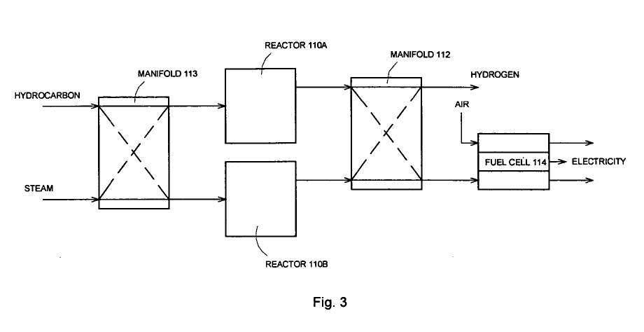

Due to the need to regenerate the reactor, the preferred design for the pyrolysis unit comprises two identical reactors operated in parallel, one is in the hydrogen production mode, while the other one is in the regeneration mode. The reactors operate alternatively, one in pyrolysis mode while the other is in the regeneration mode. The reactor in the pyrolysis mode generates hydrogen and solid carbon. The other reactor in the regeneration mode gasifies the solid carbon to generate hydrogen and CO gas mixture. The reactor in the regeneration mode then is switched to the pyrolysis mode, while the reactor in the pyrolysis mode is switched to the regeneration mode. A manifold is employed to direct the hydrocarbon and steam sources to the reactors appropriately during the pyrolysis and regeneration modes, respectively, of each reactor, to enable the two reactors to periodically alternate their role, thus ensuring a continuous hydrogen production. This time period is determined by the time it takes to partially de-activate the catalyst (case of catalytic cracking) and/or to fill up the reactor (case of thermal cracking). The outputs from the reactors are connected to a manifold that direct the hydrogen gas from the pyrolysis reaction to a hydrogen output, and the hydrogen and CO gas mixture to a fuel cell to generate electricity. FIG. 3 shows the embodiment of the design comprising only 2 reactors 110A and 110B though more than two reactors can be used. Both hydrocarbon fuel and steam are introduced to the reactors through an input manifold 113. In this embodiment, the reactors operate alternatively in pyrolysis and regeneration mode. When reactor 110A is in the pyrolysis mode, reactor 110B is in regeneration mode. Reactor 110A is then switched to the regeneration mode, and reactor 110B is switched to the pyrolysis mode. The manifold 113 thus directs the right source to the right reactor for the reactions. When reactor 110A is in the pyrolysis mode, hydrocarbon fuel is directed to reactor 110A for pyrolysis reaction to generate hydrogen, and steam is directed to reactor 110B for carbon gasification reaction. Alternatively, when reactor 110A is in the regeneration mode, steam is directed from the manifold 113 to the reactor 110A for carbon gasification, while hydrocarbon fuel is directed to reactor 110B for pyrolysis reaction. Means including valves and controls are provided in the manifold 113 to prevent contamination from the two sources during switching to the different reactors. The outputs of the reactors 110A and 110B is connected to an output manifold 112 before reaching the hydrogen output and the fuel cell 114 for proper distribution. Manifold 112 has means of valves and controls to direct the output from reactors 110A and 110B to either the hydrogen output, or to the anode of the fuel cell to generate electricity. When reactor 110A is in the pyrolysis mode, it generates hydrogen and thus the manifold directs it to the hydrogen output, and directs the output from reactor 110B that is in the regeneration mode to the fuel cell. Alternatively, when reactor 110A is in the regeneration mode and releases CO and hydrogen gas mixture, the manifold 112 directs the output from reactor 110A to the fuel cell, and the output from reactor 110B currently in the pyrolysis mode to the hydrogen output.

Using two reactors and the manifolds, this embodiment allows co-production of hydrogen and electricity continuously. A portion of the exhaust of the fuel cell that contains a large quantities of heat, steam, CO₂ and hydrogen contained gas is recycled by being directed to the reactors when they are in the regeneration mode.

The fuel utilization of the fuel cell, defined as the ratio of the number moles of hydrogen and CO converted to the number of moles of hydrogen and CO introduced, is controlled to be as high as possible, preferably above about 80%. The fuel cell exhaust thus contains large amount of steam and CO₂. Part of this exhaust is subsequently redirected to the pyrolysis reactor when the reactor operates in the regeneration mode, where it contributes to carbon gasification.

For methane fuel, one mole generates one mole of carbon and two mole of hydrogen. The two moles of hydrogen are directed to storage for future dispensing. The gasification of one mole of carbon generates one mole of syngas comprising one mole of CO and one mole of hydrogen. The electrochemical conversion of this syngas, at about 80% fuel utilization, generates a total of about 1.6 mole of steam and CO₂. This amount is sufficient for use in gasifying one mole of carbon and thus there is no need for extra steam supply.

When other longer chain hydrocarbons are used as fuel, the hydrogen to carbon ratio in the hydrocarbon molecule can be lower than about 4. As a result, the steam concentration in the fuel cell exhaust may not be sufficient and more steam from an external source is needed. The amount of extra steam depends on the hydrogen to carbon ratio of the hydrocarbon.

The efficiency of the system described in the above embodiment, defined as
η(%)=(E+ΔH_{H2})/(Lower Heating Value of Hydrocarbon Fuel)×100
wherein E denotes the electrical energy, can be estimated as followed: for one mole of methane fuel, the system creates two moles of hydrogen and one mole of syngas that is used in the fuel cell. This syngas generates about 262.4 kJ electricity and about 262.4 kJ of heat for a fuel cell operating at about 50% efficiency. On the other hand, the endothermic pyrolysis and gasification reactions at about 700° C. require a total of about 220.2 kJ of heat. This amount can be readily supplied by the waste heat from the fuel cell. Thus the system efficiency is about 93% with the electrical efficiency being about 33% and the hydrogen efficiency being about 60%.

In using the carbon, the present invention can provide 50% higher efficiency in the form of electricity, as compared to conventional pyrolysis.

In the above embodiments, the electricity output from the fuel cell is tightly related to the amount of carbon deposited in the pyrolysis reactor and thus to the hydrogen production rate. Roughly, the fuel cell will always produce roughly 262.4 kJ of electricity for every two mole of hydrogen produced (for methane fuel).

In another embodiment of the invention, the generated hydrogen from the pyrolysis reactions is also used to generate electricity. The hydrogen may go through a second fuel cell to generate electricity, or may combine with the gas mixture from the regeneration mode of the reactors to feed to the first fuel cell to generate electricity. In either scenario, the hydrocarbon fuel source is used to generate electricity at a much higher efficiency than prior art. Additional energy in form of heat can also be generated from the exhaust of the fuel cells.

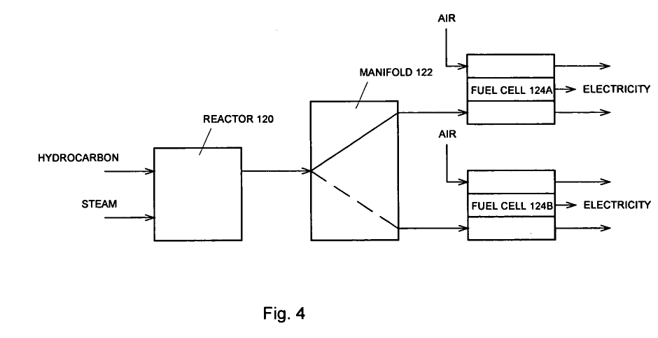

FIG. 4 shows the schematic of this embodiment, in which the hydrogen gas produced from the pyrolysis reaction in the reactor is fed to another fuel cell, preferably a high temperature fuel cell, to generate electricity. The system thus comprises the reactors for pyrolysis reactions, manifolds, and two fuel cells. The hydrogen output is used to generate electricity in the additional fuel cell, and thus the system only produces electricity. The outputs from the reactors can also be connected directly to the fuel cells, and thus the manifold can be eliminated. The exhaust from the fuel cell can also be recycled to the pyrolysis reactor when the reactor is in the regeneration mode to improve the system efficiency. The efficiency of this system can be estimated as followed:

One mole of methane generates 1 mole of carbon and 2 moles of hydrogen. The reaction requires 85 kJ at 700° C. The steam gasification of 1 mole of carbon at 700° C. requires 135.2 kJ of heat. Thus, the heat required for the pyrolysis and regeneration corresponding to 1 mole of methane inlet in the pyrolysis reactors is 220.2 kJ.

A fuel cell operating at 50% electrical conversion efficiency generates 241.8 kJ of electricity using the 2 moles of hydrogen from the pyrolysis of 1 mole of methane. For 80% fuel utilization in the fuel cell, the exhaust still contains 0.4 mole of hydrogen. This hydrogen goes through the pyrolysis reactor during the regeneration mode almost unchanged, and can serve as the fuel with the syngas for the other fuel cell. The electrochemical conversion of 0.4 mole hydrogen plus 1 mole of syngas from carbon gasification generates an extra 359.1 kJ of electricity at also 50% conversion efficiency. The total heat generated by this fuel cell, including the heat generated by the after-burner is 359.1 kJ. Therefore, the system generates a total of 601 kJ of electricity per mole of methane fuel. The system electrical efficiency is thus 75%. The calculation above is only approximate and a more rigorous system efficiency must be calculated using computer simulations and taking into account heat losses. The practical system electrical efficiency can be estimated to be in the range of 60 to 75%. The estimation indicates that starting with a typical fuel cell with 50% electrical efficiency on hydrogen, when integrated with a pyrolysis reforming, the fuel cell system can generate much higher efficiency than in prior art. The higher efficiency comes from the efficient use of the fuel cell waste heat to gasify carbon for further electricity generation. The fuel cell waste heat in prior art is typically exhausted to the environment, in which case the system efficiency is 50% or lower, or it is captured to generate hot water in Combined Heat and Power (CHP) generation. In the later case, system electrical efficiency is still 50% or lower but the thermal efficiency can also be as high as 75 to 80%, however, the useful product is not pure electricity but electricity and hot water. Except in certain particular cases, the demand for hot water does not always go with that of electricity. The present invention thus provides a system that produces useful product in form of electricity only. Electricity is known to have a much higher added value than hot water.

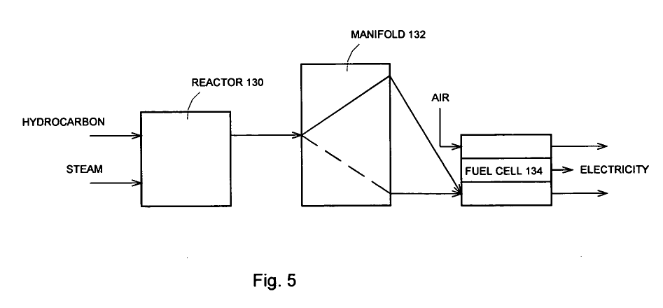

In another embodiment of the invention, only one fuel cell is needed, as shown in FIG. 5. The hydrogen output from the manifold is also directed to the fuel cell. The hydrogen produced in the pyrolysis mode of the reactor is also used to generate electricity in the fuel cell. In this configuration, the system generates electricity only, but requires only one fuel cell. A portion of the fuel cell exhaust is re-circulated back to the pyrolysis reactor that is in the regeneration mode. The fuel cell exhaust enables the gasification of carbon in the reactor in the regeneration mode. The syngas generated from the gasification is then re-directed back to the fuel cell by mixing with the hydrogen. The other portion of the fuel cell exhaust is directed to an after-burner where it is combusted to generated heat.

The amount of exhaust re-circulation is dictated by the need to have constant gas flow rate through the fuel cell and is dependent of the hydrocarbons. For each loop of gasification of 1 mole of solid carbon, the number of moles in the gas mixture increases by 1 mole. Therefore, the process is controlled to keep the number of molar flow rate constant in the fuel cell. For methane fuel, 75% of the fuel cell exhaust is re-circulated back to the pyrolysis reactors. The other 25% is combusted in the after-burner.

Additionally, small amounts of extra steam can be introduced from an external water source, especially in the case of non-methane fuel. The recirculation is adjusted consequently to take into account this extra steam.

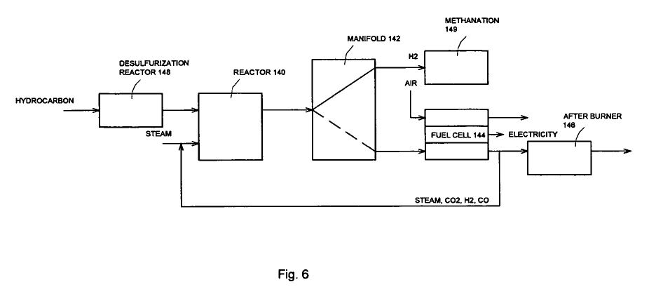

FIG. 6 shows another embodiment of the invention. This embodiment is similar to that shown in FIG. 1, but also comprises a desulfurization reactor 148 between the hydrocarbon source and the pyrolysis reactor 140, a manifold 142 after the reactor 140, and an after burner 146 at the output of the fuel cell anode, and a methanation reactor 149 at the hydrogen output of the manifold 142. In this embodiment, the hydrocarbon fuel is passed through reactor 148 to remove the sulfur in the fuel before directed to the pyrolysis reactor. The hydrogen output from the system can go through a methanation step in reactor 149 to further purify the hydrogen gas. Portion of the output from the fuel cell anode that contains steam, CO₂, and hydrogen contained gas mixture, is recycled to reactor 140 or to the steam input of reactor 140, and the remaining exhaust is sent through an after burner 146. In a preferred embodiment, the system may comprise only some of the additional component described.

In another embodiment of the invention, the invention allows the flexibility of providing the ratio of hydrogen and electricity based on immediate demands of each, while still retains the same benefits. Additional heat can also be generated in a combustion reaction. Two hydrocarbon fuel sources can be used. One source is sent to the pyrolysis reactors and the fuel cells as described above to generate hydrogen and electricity. The second source goes through a pre-reforming reactor and another fuel cell to generate electricity. The exhaust from the fuel cells is recycled to provide heat and unburned fuel to the reactors.

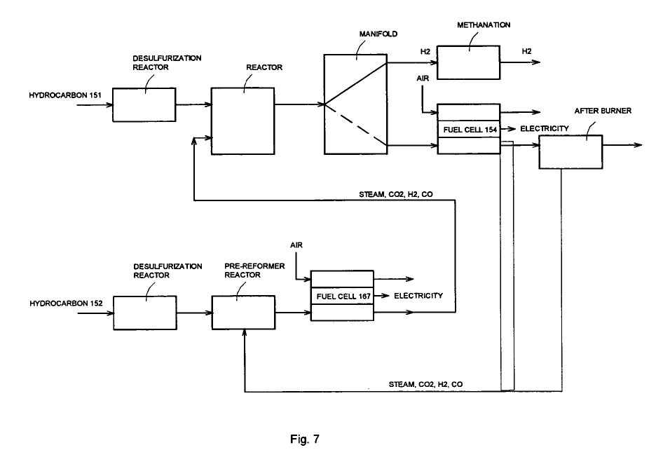

FIG. 7 shows the schematic of this embodiment in which the system comprises two hydrocarbon sources, one source Hydrocarbon 151 is intended for use in the pyrolysis reactors for hydrogen generation, while the other source Hydrocarbon 152 is intended for use in the Fuel Cell 167 for electricity generation. The two hydrocarbon sources can have the same or different chemicals. However, for compatibility with fuel cell operation, the hydrocarbon fuel to generate electricity is preferably a short chain hydrocarbon, such as methane or natural gas in order to minimize carbon deposition issue.

This embodiment allows the outputs of hydrogen and electricity independently Hydrocarbon 151 is subjected to the same process as described in the previous embodiment. It is first desulfurized, then decomposed into carbon and hydrogen gas in the pyrolysis reactors. The hydrogen is then stored for future dispensing.

Just as Hydrocarbon 151, Hydrocarbon 152 may be treated first in a desulfurization reactor if there is some sulfur in the gas. After sulfur removal, Hydrocarbon 152 is flown to a pre-reformer. The role of this pre-reformer is to reform some of the hydrocarbons, particularly the long-chain molecules that have higher susceptibility to cause carbon deposition. Steam is used as the reforming agent for the pre-reformer. The amount of steam introduced here depends on the hydrocarbon fuel. Preferred steam to carbon ratio is higher than 1 and smaller than 3, more preferably around 2. A large portion of the required steam is readily provided by the exhaust from Fuel Cell 154. The reforming generates CO, hydrogen, unreacted hydrocarbons, steam and carbon dioxide. The pre-reformer is set to reform between about 10 to 80%, and more preferably between about 10 to 50% of the inlet hydrocarbons. The exhaust from the pre-reformer is then composed of essentially CO, hydrogen, unreacted hydrocarbons, steam and carbon dioxide.

The gas coming out of the pre-reformer is directed to the anode of Fuel Cell 167, where it is converted electrochemically to generate electricity. The conversion also generates steam and CO₂. The exhaust from the fuel cell 167 is then directed to the pyrolysis reactor during the regeneration mode. Steam and CO₂ enable carbon gasification into CO and hydrogen gases.

There are some options regarding the use of the syngas generated by carbon gasification. In one preferred embodiment of the invention, the syngas from the cracking reactor during the regeneration phase is directed to a high temperature fuel cell. This fuel cell can be a different fuel cell unit than the one above or can be the same. The syngas constitutes the fuel for this fuel cell to generate electricity. Therefore, through the gasification, carbon black becomes a useful fuel. In contrast to other art, this fuel is converted to electricity using an electrochemical process that is about twice more efficient than conventional combustion.

FIG. 7 shows an embodiment where the syngas is directed to a fuel cell 154 to be converted electrochemically to generate electricity. The fuel utilization in Fuel Cell 154 is controlled to be as high as possible, preferably about 80% or higher. The fuel cell exhaust thus contains a large amount of steam and CO₂. A portion of the exhaust gas from Fuel Cell 154 is then recirculated back to the pre-reformer where it contributes to the pre-reforming of Hydrocarbon 152. The remaining portion is then combusted in an after-burner to generate heat. This heat is used to supply to the boiling of water to provide steam for the pre-reforming, and to promote the endothermic pyrolysis and gasification reactions.

The system efficiency can be estimated as followed:

For Fuel Cell 167, one mole of methane fuel (Hydrocarbon 2) generates about 401.4 kJ of electricity if the fuel cell efficiency is controlled to be at approximately 50% and 80% fuel utilization.

On the other hand, the pyrolysis of 1 mole of methane (Hydrocarbon 151) at about 700° C. requires 85 kJ. The pyrolysis of 1 mole of methane generates 1 mole of carbon black and 2 moles of hydrogen. The steam gasification of 1 mole of carbon at about 700° C. requires about 135.2 kJ of heat. Thus, the heat required for the pyrolysis and regeneration corresponding to 1 mole of methane inlet in the pyrolysis reactors is about 220.2 kJ.

The gasification of one mole of carbon generates one mole of CO and one mole of hydrogen. When added to the approximately 20% of unburnt fuel coming from Fuel Cell 154, which contains 0.2 mole CO and 0.6 mole hydrogen (assuming no water shift reaction), the total fuel available is about 1.2 mole CO and about 1.6 mole hydrogen. This gas is then used in Fuel Cell 154, to generate roughly an extra 363.2 kJ electricity for an efficiency controlled at about 50%. The heat generated from Fuel Cell 154, including the after-burner is then about 363.2 kJ. This heat is sufficient to supply to the pyrolysis and carbon gasification as well as the boiling of up to about 3 moles of water for the pre-reforming of Hydrocarbon 152.

Therefore, the system above consumes one mole of methane in Fuel Cell 167 and one mole of methane in the pyrolysis reactors to generate a total of about 764.6 kJ electricity in both fuel cells and 2 moles of hydrogen fuel. The system efficiency is thus approximately 78%, with the electrical efficiency being approximately 48% and the hydrogen efficiency approximately 30%.

The flow rates of methane in Fuel Cell 167 and in the pyrolysis reactors are not required to be the same. The requirement is to operate the system at isothermal where the efficiency is maximal or exothermic where the electricity to hydrogen output ratio of the system is higher than that of the above example.

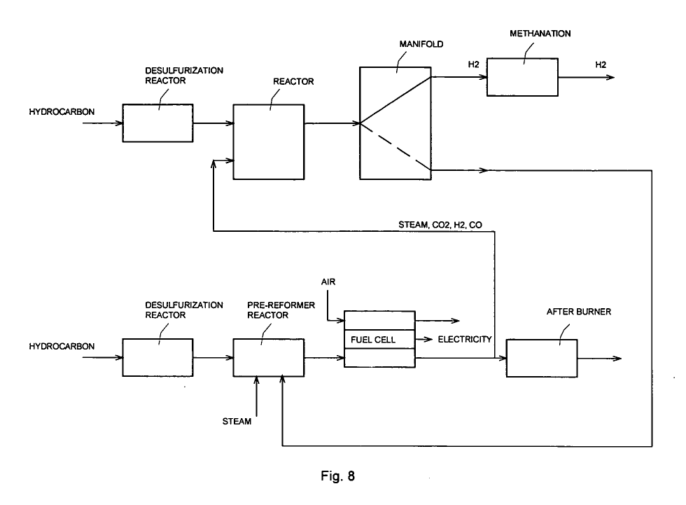

Alternatively, only one fuel cell unit is needed. FIG. 8 shows the configuration of the system with only one fuel cell. The fuel cell that is connected to the pyrolysis reactors through the manifold has been eliminated. The syngas produced during the regeneration mode of the reactor is directed to the pre-reformer reactor and combined with the incoming hydrocarbon fuel source to generate electricity in the fuel cell. A portion of the exhaust from the fuel cell is directed to the pyrolysis reactors, and the remainder is sent through an after burner.

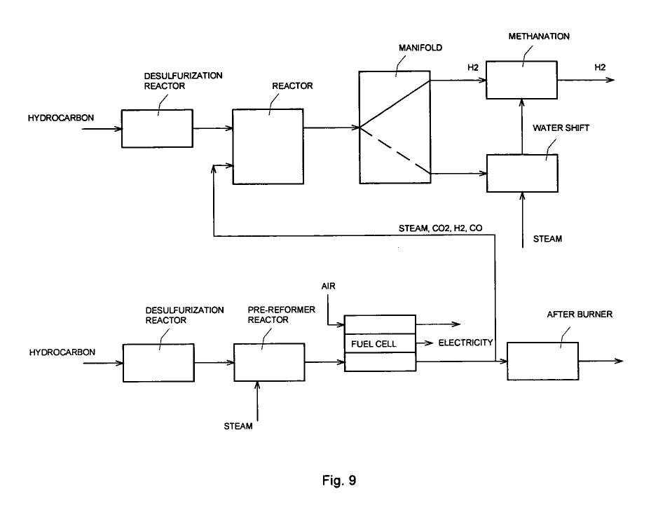

Another option regarding the use of syngas is to produce pure hydrogen. FIG. 9 shows the embodiment according to this configuration. Similar to that shown in FIG. 8, the system comprises of two hydrocarbon fuel sources, the pyrolysis reactors, and one fuel cell. In this embodiment however, the syngas produced during the regeneration mode of the reactor is further purified to produce hydrogen. In this option, the syngas leaving the pyrolysis reaction in the regeneration mode is directed to a high and a low temperature water shift reactors to convert the majority of CO gas into hydrogen. The residual CO in the gas is subsequently removed in either a methanation or a preferential oxidation reactor. The preferred option is to use hydrogen separation technologies to purify hydrogen for storage. In this embodiment, both the hydrogen and syngas output from the pyrolysis reactors of the one hydrocarbon fuel source combine to produce hydrogen, while the second hydrocarbon fuel source generates electricity through a fuel cell.

The efficiency for this embodiment can be estimated as followed:

For Fuel Cell I, one mole of methane fuel (Hydrocarbon 2) generates about 401.4 kJ of electricity if the fuel cell efficiency is controlled to be at approximately 50% and 80% fuel utilization.

On the other hand, the pyrolysis of 1 mole of methane (Hydrocarbon 1) at about 700° C. requires about 85 kJ. The pyrolysis of 1 mole of methane generates 1 mole of carbon black and 2 moles of hydrogen. The steam gasification of 1mole of carbon at about 700° C. requires about 135.2 kJ of heat. Thus, the heat required for the pyrolysis and regeneration corresponding to 1 mole of methane inlet in the pyrolysis reactors is about 220.2 kJ. The heat required to boil two moles of water for the pre-reformer is about 88 kJ, thus the total heat requirement is about 308 kJ.

The gasification of one mole of carbon generates 1 mole of CO and one mole of hydrogen. After treatment, the CO is converted to hydrogen in the water shift reactors. The heat generated by the water shift is about 41 kJ, thus reducing the total system heat requirement to about 267 kJ. This is well below the heat generated by Fuel cell I. The total amount of hydrogen generated by the system is thus four moles. The system efficiency is about 85%, with the electrical efficiency being about 25% and the hydrogen efficiency about 60%.

Although the above calculation is only approximate, and more accurate efficiency number can be obtained using computer calculations, the result still demonstrate a higher efficiency for the present invention as compared to the typical 50% obtained in prior art on fuel cell system. The system efficiency is also much higher than the efficiency obtained in the art on hydrocarbon pyrolysis (which is less than 60%). This demonstrates the benefit of coupling two generation processes, one endothermic and one exothermic, in one.

In most applications, it is desirable to have hydrogen under high pressures. Additionally, a compressor can be used after the hydrogen purification step to compress hydrogen for storage in high pressure tanks. The compressor can be either mechanical or electrochemical or a combination of both.

Another embodiment of the present invention consists of performing the pyrolysis then gasifying the carbon using a high temperature fuel cell without having the two systems thermally integrated. The carbon becomes the fuel for the fuel cell. This embodiment has applications where there is need for compact and easy hydrogen fuel processor such as in transportation.

Therefore, the embodiments of the present invention has the following advantages:
carbon from the pyrolysis is converted to syngas, a highly valuable mixture, using the steam and CO₂ from the high-temperature fuel cell.
the syngas generated by the gasification is used to further generate electricity or hydrogen fuel.
the steam that is needed for carbon gasification is provided partially or totally as a “free” by-product of the fuel cell reaction.
the heat that is needed for the endothermic gasification is provided also as a “free” by-product of the fuel cell reaction.
the heat and steam generated by the fuel cell in the present invention are used efficiently to generate more electricity or hydrogen fuel. This is in sharp contrast with prior art related to fuel cell, where the heat is either released to the environment or is used in Combined Heat and Power (CHP) generation. Compared to hydrogen and electricity, heat has far less value.
the system efficiency of the present invention is much higher than in prior art related to single purpose systems.
the system has also great flexibility in the output of electricity and hydrogen.

Due to the possibility of co-generation of hydrogen and electricity, the embodiment of the present invention is highly suitable for use as energy stations. These energy stations would function similarly to the current refueling stations—their role will be to provide hydrogen for refueling hydrogen based vehicles. Additionally, the energy stations will also provide electricity for the neighborhood. The difference with the refueling stations is that the present energy stations will generate their own electricity and hydrogen fuel using existing fuel infrastructure including natural gas, LPG, gasoline, etc.

From this application perspective, the energy station also comprises a hydrogen storage unit that will serve as buffer between the production and demand.

The embodiments of the present invention can also be used in applications where co-generation of hydrogen and electricity is needed.

As described above, the present invention provides several embodiments that have a wide range of applications, as scaling of the configurations for various applications can be readily accomplished by those skilled in the art. While particular embodiments, materials, parameters, etc. have been illustrated and/or described, such are not intended to be limiting. Various modifications, and equivalent substitutes may be incorporated into the invention as described above without varying the spirit of the invention, as will also be apparent to those skilled in this technology. In other instances, well-known process operations were not described in details in order not to unnecessarily obscure the present invention. In particular, various engineering details, including heat exchangers, blowers, valves, boilers, after-burner, electrical connections, etc. were purposely left out of the discussion. Those skilled in the art should be able to incorporate these components to the new system described above. In another instance, the system can be designed to operate at pressures above ambient. Furthermore, while particular terminology is used in the description above to describe certain aspects of the present invention, one skilled in the art would understand that other equivalent terms may be substituted therefor. For example, the term “air” is used herein, for convenience sake, to refer to any oxygen containing gas suitable for use in the fuel cells. Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation.

1. A system capable of generating both electricity and hydrogen from hydrocarbon fuels, the system comprising
a plurality of hydrocarbon pyrolysis reactors, the hydrocarbon pyrolysis reactors capable of operating in pyrolysis mode or in regeneration mode;
a plurality of fuel cells; and
a manifold in communication with the pyrolysis reactors and the fuel cells, the manifold capable of directing the output of the pyrolysis reactors in regeneration mode to the fuel cells, wherein
in pyrolysis mode, the pyrolysis reactors utilize the hydrocarbon fuels to generate hydrogen and solid carbon, and
in regeneration mode, the pyrolysis reactors convert the solid carbon to electricity by an electrochemical process through the fuel cells.

2. A system as in claim 1 wherein the fuel cells are high temperature fuel cells.

3. A system as in claim 2 wherein the high temperature fuel cells operate at 400° C. or higher.

4. A system as in claim 1 wherein the fuel cells are molten carbonate fuel cells or solid oxide fuel cells.

5. A system as in claim 1 wherein the hydrocarbon fuels include natural gas, methane, propane, butane, parrafins, liquidfied petroleum gas, gasoline, diesel, methanol, thanol, propanol.

6. A system as in claim 1 wherein the pyrolysis reactors operate by the pyrolysis of hydrocarbon fuels.

7. A system as in claim 1 wherein the pyrolysis reactors operate by the thermal or catalytic decomposition of hydrocarbon fuels.

8. A system as in claim 1 wherein the pyrolysis reactors comprise at least two reactors, one in pyrolysis mode and one in regeneration mode, the two reactors periodically alternating their role.

9. A system as in claim 1 further comprising a methanation unit or a preferential oxidation reactor or a hydrogen separation unit connecting to the pyrolysis reactor output to remove CO.

10. A system as in claim 1 further comprising a hydrogen storage unit to store the hydrogen generated by the pyrolysis reactor in pyrolysis mode.

11. A system as in claim 1 wherein in regeneration, solid carbon is gasified into carbon monoxide and hydrogen.

12. A system as in claim 1 wherein steam is provided to the pyrolysis reactor for the carbon gasification process.

13. A system as in claim 1 wherein the steam to the pyrolysis reactor is provided by the exhaust of the fuel cell.

14. A system as in claim 1 wherein the steam to the pyrolysis reactor is provided by the exhaust of an external fuel cell.

15. A system as in claim 1 wherein the exhaust generated by the fuel cell is re-directed back to the reactor to improve the reactor efficiency.

16. A system as in claim 1 wherein the heat generated by the fuel cell is re-directed back to the reactor to improve the reactor efficiency.

17. A system as in claim 1 further comprising a water shift reactor in communication with the pyrolysis reactors to convert carbon monoxide to hydrogen.

18. A system as in claim 1 further comprising a CO removal unit in communication with the pyrolysis reactors to remove carbon monoxide.

19. A system as in claim 1 further comprising a hydrogen purification unit in communication with the pyrolysis reactors to purify the hydrogen exhaust.

20. A system as in claim 1 further comprising a hydrogen storage unit in communication with the hydrogen purification unit.

21. A system as in claim 1 further comprising a mechanical and/or electrochemical compressor to compress hydrogen prior to storage.

22. A method to produce both hydrogen and electricity using a hydrocarbon pyrolysis reactor capable of operating in pyrolysis mode or in regeneration mode, the method comprising
putting the hydrocarbon pyrolysis reactor into the pyrolysis mode;
providing hydrocarbon fuel to the hydrocarbon pyrolysis reactor;
decomposing the hydrocarbon fuel into hydrogen and solid carbon;
putting the hydrocarbon pyrolysis reactor into the regeneration mode;
providing a steam mixture to the hydrocarbon pyrolysis reactor;
gasifying solid carbon into carbon monoxide and hydrogen;
directing the carbon monoxide and hydrogen mixture to a fuel cell; and
electrochemically oxidizing the carbon monoxide and hydrogen mixture in a fuel cell to generate electricity.

23. A method as in claim 22 comprising a plurality of hydrocarbon pyrolysis reactors wherein one set of reactors is in pyrolysis mode and other set of reactors is in regeneration mode whereby hydrogen and electricity are generated continuously.

24. A method as in claim 22 wherein the steam mixture provided to the hydrocarbon pyrolysis reactor is generated from another fuel cell.

25. A method as in claim 22 wherein the steam mixture provided to the hydrocarbon pyrolysis reactor also comprises carbon dioxide and is generated from another fuel cell.

26. A method as in claim 22 wherein the fuel cell further comprises a hydrocarbon fuel input.

27. A method as in claim 22 wherein the fuel cells are high temperature fuel cells.

28. A method as in claim 22 wherein the high temperature fuel cells operate at 400° C. or higher.

29. A method as in claim 22 wherein the fuel cells are molten carbonate fuel cells or solid oxide fuel cells.

30. A method as in claim 22 wherein the pyrolysis reactors operate by the pyrolysis of hydrocarbon fuels.

31. A method as in claim 22 wherein the pyrolysis reactors operate by the thermal or catalytic decomposition of hydrocarbon fuels.

32. A method as in claim 22 further comprising a methanation step or a preferential oxidation step or a hydrogen separation step to remove CO.

33. A method as in claim 22 wherein the steam to the pyrolysis reactor is provided by the exhaust of the fuel cell.

34. A method as in claim 22 wherein the steam to the pyrolysis reactor is provided by the exhaust of an external fuel cell.

35. A method as in claim 22 wherein the exhaust generated by the fuel cell is re-directed back to the reactor to improve the reactor efficiency.

36. A method as in claim 22 wherein the heat generated by the fuel cell is re-directed back to the reactor to improve the reactor efficiency.

37. A method as in claim 22 further comprising a mechanical and/or electrochemical compressor to compress hydrogen to high pressures prior to storage in high pressure tanks.

38. A method to produce both hydrogen and electricity using a hydrocarbon pyrolysis reactor capable of operating in pyrolysis mode or in regeneration mode, the method comprising
putting the hydrocarbon pyrolysis reactor into the pyrolysis mode;
providing hydrocarbon fuel to the hydrocarbon pyrolysis reactor;
decomposing the hydrocarbon fuel into hydrogen and solid carbon;
providing hydrocarbon fuel to a fuel cell;
electrochemically oxidizing the carbon monoxide and hydrogen mixture in a fuel cell to generate electricity;
putting the hydrocarbon pyrolysis reactor into the regeneration mode;
directing the fuel exhaust to the hydrocarbon pyrolysis reactor;
gasifying solid carbon into carbon monoxide and hydrogen; and
directing the carbon monoxide and hydrogen mixture to a water shift reactor to increase the hydrogen content.

39. A method as in claim 38 comprising a plurality of hydrocarbon pyrolysis reactors wherein one set of reactors is in pyrolysis mode and other set of reactors is in regeneration mode whereby hydrogen and electricity are generated continuously.

40. A method as in claim 38 further comprising a carbon monoxide removal step.

41. A method as in claim 38 further comprising a hydrogen separation step.

42. A method as in claim 38 wherein the fuel cells are high temperature fuel cells.

43. A method to produce electricity using a hydrocarbon pyrolysis reactor capable of operating in pyrolysis mode or in regeneration mode, the method comprising
putting the hydrocarbon pyrolysis reactor into the pyrolysis mode;
providing hydrocarbon fuel to the hydrocarbon pyrolysis reactor;
decomposing the hydrocarbon fuel into hydrogen and solid carbon;
directing the hydrogen to a fuel cell;
electrochemically oxidizing the hydrogen in the fuel cell to generate electricity;
putting the hydrocarbon pyrolysis reactor into the regeneration mode;
providing a steam mixture to the hydrocarbon pyrolysis reactor;
gasifying solid carbon into carbon monoxide and hydrogen;
directing the carbon monoxide and hydrogen mixture to a fuel cell; and
electrochemically oxidizing the carbon monoxide and hydrogen mixture in the fuel cell to generate electricity.

44. A method as in claim 43 comprising a plurality of hydrocarbon pyrolysis reactors wherein one set of reactors is in pyrolysis mode and other set of reactors is in regeneration mode whereby hydrogen and electricity are generated continuously.

45. A method as in claim 43 wherein there are at least two fuel cells, one for receiving hydrogen during the reactor pyrolysis mode and another for receiving carbon monoxide and hydrogen mixture during the reactor regeneration mode.

46. A method as in claim 43 wherein the fuel cell receiving the reactor output during both pyrolysis mode and regeneration mode is the same.

47. A method as in claim 43 wherein the fuel cells are high temperature fuel cells.

48. A method as in claim 43 wherein the hydrocarbon fuels include natural gas, methane, propane, butane, parrafins, liquidfied petroleum gas, gasoline, diesel, methanol, thanol, propanol.

49. A method as in claim 43 wherein the pyrolysis reactors operate by the pyrolysis of hydrocarbon fuels.

50. A method as in claim 43 wherein the pyrolysis reactors operate by the thermal or catalytic decomposition of hydrocarbon fuels.

51. A method as in claim 41 wherein the steam to the pyrolysis reactor is provided by the exhaust of the fuel cell.

52. A method as in claim 43 wherein the exhaust generated by the fuel cell is re-directed back to the reactor to improve the reactor efficiency.

53. A method as in claim 43 wherein the heat generated by the fuel cell is re-directed back to the reactor to improve the reactor efficiency.

54. A method to maximize energy use of the carbon generated by pyrolysis, comprising the steps of
gasifying carbon using a mixture of steam and CO₂, and
using the products of the carbon gasification as the fuel in a high
temperature fuel cell to generate electricity.

55. A method as in claim 54, further comprising the step of using the fuel cell exhaust as the steam/CO₂ source to gasify carbon.
